(19) United States
(12) Patent Application Publication
(10) Pub. No.: US 2014/0335432 A1
(43) Pub. Date: Nov. 13, 2014

(54) SYSTEMS AND METHODS FOR ESTIMATING FUEL CELL STATES

(71) Applicant: GM GLOBAL TECHNOLOGY OPERATIONS LLC, Detroit, MI (US)

(72) Inventors: MANISH SINHA, PITTSFORD, NY (US); MATTHEW A. LANG, CHURCHVILLE, NY (US); DANIEL C. DI FIORE, SCOTTSBURG, NY (US); STEVEN R. FALTA, HONEOYE FALLS, NY (US)

(73) Assignee: GM GLOBAL TECHNOLOGY OPERATIONS LLC, Detroit, MI (US)

(21) Appl. No.: 13/889,147

(22) Filed: May 7, 2013

(51) Int. Cl. H01M 8/04

(52) U.S. Cl. CPC H01M 8/04447; H01M 8/04559; H01M 8/04619; H01M 8/04589; H01M 8/0432; H01M 2250/20
USPC 429/431; 429/432; 324/426

(57) ABSTRACT

Apparatus, methods, and systems for estimating hydrogen concentration and/or pressure in an anode compartment of a fuel cell stack in a fuel cell vehicle. In some implementations, the estimates are based on a correlation between a transient dip in voltage in response to an anode to cathode bleed event and a concentration of hydrogen in the anode compartment of a fuel cell stack. Some implementations may comprise initiating a bleed event, sensing a transient dip in voltage in response to the bleed event, and using the correlation to calculate an estimate of a concentration and/or pressure of the gas in the anode compartment. The sensitivity of the correlation and hence the accuracy of estimation may change with the power level and may be accounted for in the correlation.

### TECHNICAL FIELD

This disclosure relates to apparatus, methods, and systems for estimating fuel cell states. For example, in some embodiments, this disclosure relates to estimating the concentration of a gas, such as hydrogen, within a compartment of a fuel cell stack in a fuel cell vehicle.

### BACKGROUND

Fuel cell systems typically operate by use of hydrogen or a hydrogen-rich gas that is supplied through a flowpath to the anode side of a fuel cell while oxygen is supplied to the cathode side of the fuel cell. In some such systems known as proton exchange membrane fuel cells, an electrolyte in the form of a membrane is sandwiched between the anode and cathode to produce a layered structure commonly referred to as a membrane electrode assembly. Each such assembly may form a single fuel cell, and a plurality of these cells may then be combined to form a fuel cell stack.

The stack voltage is typically insensitive to hydrogen concentration due to the fast hydrogen oxidation reaction kinetics and low hydrogen mass transfer. Consequently, barring a hydrogen starvation event, the stack voltage typically shows no sensitivity to the concentration of hydrogen. Moreover, the AC impedance response also typically shows little or no sensitivity to hydrogen concentration. Thus, it has been assumed that the use of a stack voltage to infer hydrogen concentration in an anode compartment of a fuel cell stack is not feasible.

Due to this perceived infeasibility, the concentration of hydrogen within an anode compartment is either not available, or nitrogen sensors are used to indirectly determine hydrogen concentrations. However, since nitrogen sensors are relatively expensive, it may be desirable to eliminate the need for such sensors and to estimate nitrogen and/or hydrogen concentration by other means. The present inventors have therefore determined that it would be desirable to provide apparatus, methods, and systems for estimating fuel cell states, such as estimating the concentration of hydrogen in an anode compartment of a fuel cell stack, for example, in order to overcome one or more such limitations and/or other limitations of the prior art.

### SUMMARY

Apparatus, methods, and systems are disclosed herein for estimating fuel cell states. For example, some embodiments may be configured to estimate the concentration of a gas, such as hydrogen, within a compartment of a fuel cell stack in a fuel cell vehicle. Some embodiments, as discussed below, may provide such an estimate by sensing a voltage change during a bleed event associated with the fuel cell stack.

In some implementations of a method for estimating a state of an anode compartment of a fuel cell stack, the method may comprise determining an at least approximate correlation between a change in voltage associated with a bleed event and a concentration of a gas, such as hydrogen, in the anode compartment. This correlation may be determined by, for example, initiating a series of bleed events at known hydrogen concentrations and recording voltage changes for each of the bleed events in the series. The step of determining an at least approximate correlation between a change in voltage associated with a bleed event and a concentration of gas in the anode compartment may further comprise plotting the voltage changes relative to the known hydrogen concentrations. Various other parameters that may impact this relationship, such as temperature, and power/current density for example, may also be built into such models to improve upon accuracy/sensitivity.

The step of determining an at least approximate correlation between a change in voltage associated with a bleed event and a concentration of gas in the anode compartment may further comprises interpolating data between the plotted voltage changes to allow for calculation of an estimated concentration of hydrogen in the anode compartment associated with voltage changes in between the plotted voltage changes.

In some implementations, after the correlation between a change in voltage associated with a bleed event and a concentration of a gas in the anode compartment is determined, a bleed event may be initiated. Such a bleed event may comprise, for example, opening a bleed valve. Such a bleed valve may be configured to deliver gas from the anode compartment to the cathode compartment of the fuel cell stack.

In some implementations, a change in voltage associated with the bleed event may be sensed. The change in voltage may, in some implementations, comprise an average cell voltage of a plurality of cells in the fuel cell stack. The average cell voltage may comprise an average voltage of all of the cells in the fuel cell stack.

The correlation may then be used to calculate an estimate of a concentration of the gas in the anode compartment. This estimate may then be used to adjust one or more functions of the vehicle and/or fuel cell system.

In another example of a method for estimating a state of an anode compartment of a fuel cell stack of a fuel cell vehicle, the method may comprise determining an at least approximate correlation between a change in voltage associated with a bleed event at a particular power state and a concentration of hydrogen in the anode compartment. The power state may be determined, for example, by a current sensor, coupled with the fuel cell system.

This implementation may comprise initiating a bleed event and sensing a power state associated with the bleed event. Again, the power state may be sensed, for example, using a current sensor (such as a current density sensor) or otherwise sensing a power state associated with the fuel cell stack. A change in voltage associated with the bleed event may then be sensed. This may be accomplished, for example, by detecting a voltage change of the stack during the bleed event.

The correlation may then be used to calculate an estimate of a concentration of hydrogen in the anode compartment at the sensed power state. One or more operational states of the vehicle may then be adjusted in response to the estimated concentration of hydrogen. In some implementations, the step of adjusting one or more operational states of the vehicle may comprise adjusting a nitrogen buildup model of the fuel cell stack. In some implementations, adapting a nitrogen buildup model of the fuel cell stack may comprise resetting the nitrogen buildup model.

In other implementations, other parameters may also be used to improve the accuracy and/or sensitivity of the estimated gas concentration. For example, a temperature associated with the bleed event, such as a temperature of the fuel cell stack during the bleed event, may be used such that the correlation between the voltage change and the gas concentration may take such a temperature into account. In other implementations, a more general temperature may be used as a proxy for the precise temperature of the stack during the bleed event if desired. For example, a temperature sensed before (or after) the bleed event may be used in calculating or otherwise determining the estimated gas concentration. As another example, a power state associated with the bleed event, such as a current density, may also, or alternatively, be used such that the correlation between the voltage change and the gas concentration may take such a power state into account.

In implementations utilizing a sensed temperature and/or sensed power state, the step of using the correlation to calculate an estimate of a concentration of hydrogen in the anode compartment at the sensed power state may comprise using the sensed temperature and/or the sensed power state to calculate an estimate of a concentration of hydrogen in the anode compartment at the sensed power state and/or at the sensed temperature.

In some embodiments of vehicles, such as fuel cell vehicles, comprising a means for estimating a fuel cell stack gas concentration, the vehicle may comprise a fuel cell stack comprising an anode compartment. The vehicle may further comprise a bleed valve fluidly coupled with the anode compartment. In some embodiments, the bleed valve may be configured to, open being actuated, release a gas, such as nitrogen, from the anode compartment to a cathode compartment of the fuel cell stack.

In some embodiments, a voltage sensor may be provided. Such a voltage sensor may be configured to detect a voltage associated with the fuel cell stack during a bleed event using the bleed valve. Some embodiments may further comprise a gas concentration module for estimating a concentration of a gas in the anode compartment. The gas concentration module may be configured to use a correlation between a change in voltage associated with a bleed event using the bleed valve and a concentration of the gas in the anode compartment to estimate the concentration of the gas.

In some embodiments, the vehicle may lack an anode gas pressure sensor, since the principles disclosed herein may, as mentioned above, allow for replacing such a sensor (such as a nitrogen gas sensor) with a means for estimating the concentration of a gas, such as hydrogen gas, that utilizes voltage changes, as described herein.

In some embodiments, the vehicle may further comprise a temperature sensor. In such embodiments, the gas concentration module may be configured to use temperature data from the temperature sensor to estimate the concentration of the gas in the anode compartment.

In some embodiments, the vehicle may further comprise a current sensor, such as a current density sensor. In such embodiments, the current density sensor may be configured to sense a current density during a bleed event. In such embodiments, the gas concentration module may be configured to use data from the current density sensor obtained during a bleed event to estimate the concentration of the gas in the anode compartment.

### BRIEF DESCRIPTION OF THE DRAWINGS

Non-limiting and non-exhaustive embodiments of the disclosure are described, including various embodiments of the disclosure with reference to the figures, in which:

FIG. 1 is a graph illustrating a relationship between a voltage change occurring during a bleed event associated with a fuel cell stack and the hydrogen gas concentration within an anode compartment of the fuel cell stack at a first power state.

FIG. 2 is a graph illustrating a relationship between a voltage change occurring during a bleed event associated with a fuel cell stack and the hydrogen gas concentration within an anode compartment of the fuel cell stack at a second power state greater than the first power state.

FIG. 3 is a block diagram illustrating one embodiment of a fuel cell stack comprising a voltage sensor.

FIG. 4 is a graph illustrating relationships between voltage changes occurring during bleed events associated with a fuel cell stack and a concentration of hydrogen within an inlet of a cathode compartment of the fuel cell stack at differing power states.

FIG. 5 is a graph illustrating a relationship between voltage changes occurring during bleed events and a pressure bias within an anode compartment of a fuel cell stack.

FIG. 6 is a flow chart illustrating one implementation of a method for estimating a state of an anode compartment of a fuel cell stack of a fuel cell vehicle.

FIG. 7 illustrates an example of a vehicle incorporating a system for estimating a state of an anode compartment of a fuel cell stack of the vehicle.

### DETAILED DESCRIPTION

A detailed description of systems and methods consistent with various embodiments of the present disclosure is provided below. While several embodiments are described, it should be understood that disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure will be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

Embodiments of the apparatus, systems, and methods disclosed herein may be used to estimate a state of a compartment of a fuel cell stack of a fuel cell vehicle. More specific embodiments and implementations will now be described in greater detail with reference to the accompanying drawings.

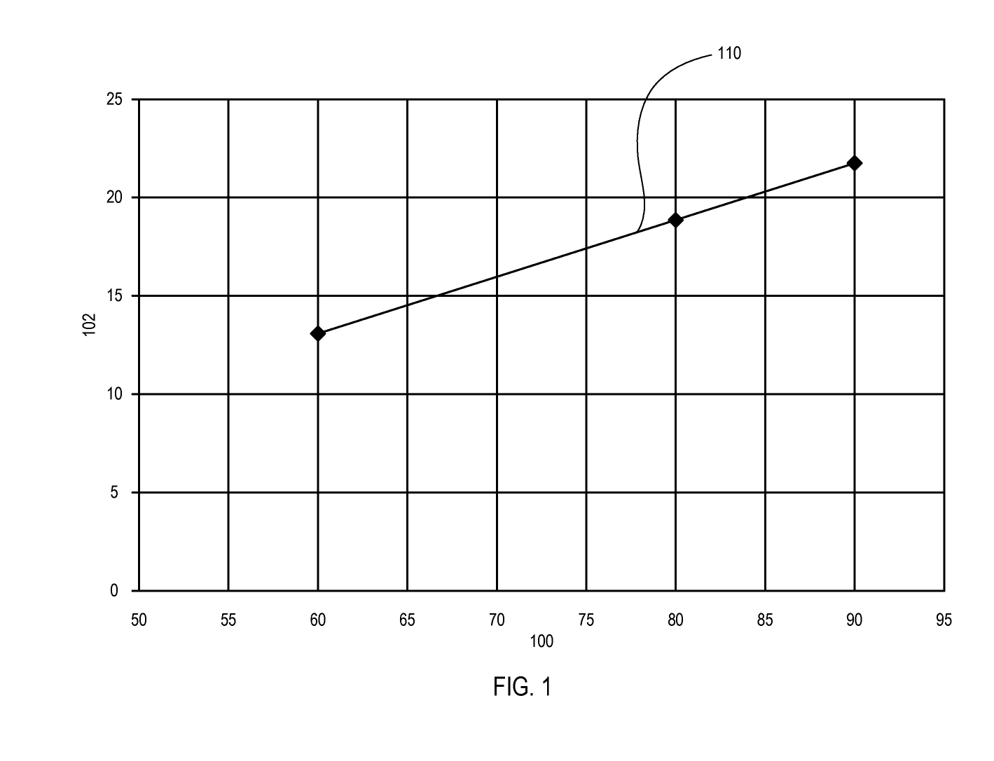

FIG. 1 illustrates a graph illustrating a relationship between a voltage change occurring during a bleed event associated with a fuel cell stack and the hydrogen gas concentration within an anode compartment of the fuel cell stack at a first power state. As shown in this graph, the concentration of a gas, such as hydrogen gas within an anode compartment of a fuel cell stack, may vary and be at least somewhat predictable based upon a voltage change during a bleed event, such as actuating a bleed valve to allow gas in an anode compartment to be directed to an inlet of a cathode compartment of the fuel cell stack. The hydrogen gas concentration (as a percentage) is plotted along the “X” axis of FIG. 1 at 100. The voltage drop (in mV) measured during the bleed event is plotted along the “Y” axis of FIG. 1 at 102. The data plotted in FIG. 1 was obtained at a current density of about 0.02 A/cm².

The graph of FIG. 1 illustrates that a larger drop in voltage during the bleed event generally correlates with a higher concentration of hydrogen within the anode compartment. By interpolating from the plotted data, a more general relationship can be determined, as indicated by line 110, so that an estimated gas concentration at any measured voltage change can be obtained at a particular power state (again, about 0.02 A/cm² in FIG. 1).

It appears that the stack voltage also exhibits a drop that is correlated to both the anode concentration and the pressure bias. The higher the hydrogen concentration in the anode compartment, the higher the voltage drop. And, similarly, the higher the pressure bias, the higher the voltage drop. Thus, as discussed below, in some embodiments and implementations, the voltage drop during a bleed event may be used not only to estimate a gas concentration, but may also, or alternatively, be used to estimate a pressure bias, such as a pressure bias in the anode compartment of a fuel cell stack. Both the pressure bias and the gas concentration can be considered “states” of a compartment of a fuel cell stack, such as an anode compartment of a fuel cell stack, that may be estimated using the inventive principles disclosed herein. Without being limited by theory, it is thought that, since, in general, both the anode pressure and the anode gas concentration define the hydrogen flowrate to the cathode, this effective hydrogen-related oxygen starvation may cause the voltage drop. The current density shift, surface reaction on the catalyst, and/or partial pressure change of the anode may also, or alternatively, be responsible for the voltage drop.

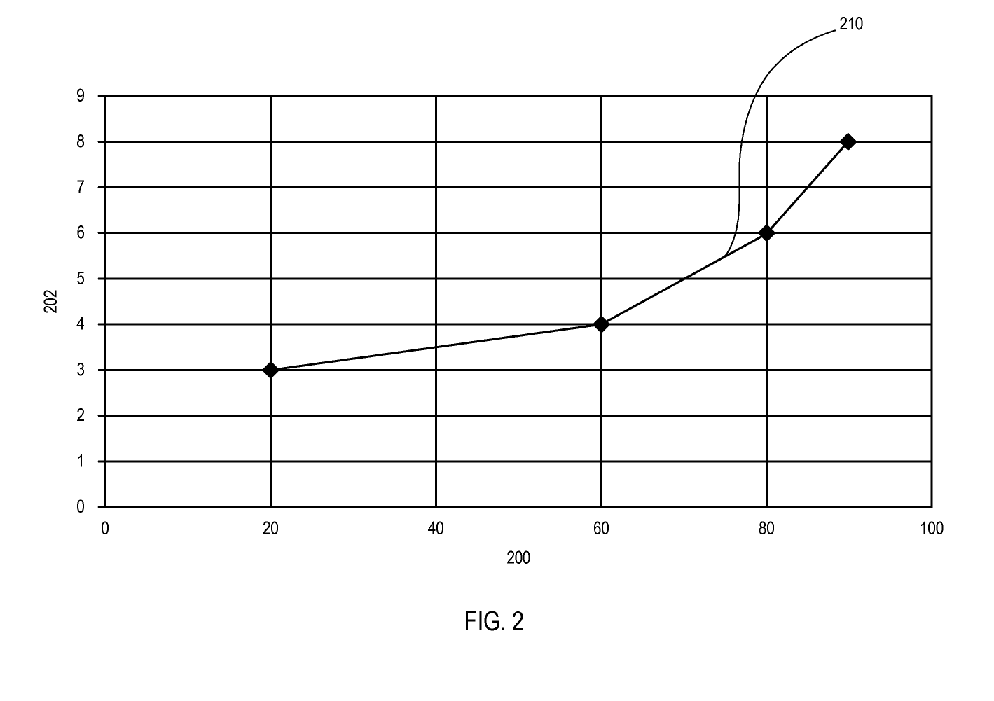

FIG. 2 is a similar graph illustrating a relationship between a voltage change occurring during a bleed event associated with a fuel cell stack and a hydrogen gas concentration within an anode compartment of the fuel cell stack at a second power state greater than the first power state. More particularly, the data shown in FIG. 2 was generated at a power state of about 0.2 A/cm².

As shown in FIG. 2, and as previously described in connection with FIG. 1, the concentration of a gas, such as hydrogen gas, within an anode compartment of a fuel cell stack may vary and be at least somewhat predictable based upon a voltage change during a bleed event, such as actuating a bleed valve to allow gas in an anode compartment to be directed to an inlet of a cathode compartment of the fuel cell stack. The gas concentration (as a percentage) is plotted along the “X” axis of FIG. 2 at 200. The voltage drop (in mV) measured during the bleed event is plotted along the “Y” axis of FIG. 2 at 202. As can be seen by comparing FIGS. 1 and 2, the power state (such as current density) of the fuel cell stack may impact the amount of voltage drop. As such, in some embodiments and implementations, a power state or power state information may be incorporated into a system and/or method for estimating a gas concentration.

As with the data shown in the graph of FIG. 1, the graph of FIG. 2 illustrates that a larger drop in voltage during the bleed event generally correlates with a higher concentration of hydrogen within the anode compartment. Thus, again, by interpolating from the plotted data, a more general relationship can be determined, as indicated by line 210, so that an estimated gas concentration at any measured voltage change can be obtained at a particular power state (again, about 0.2 A/cm² in FIG. 2).

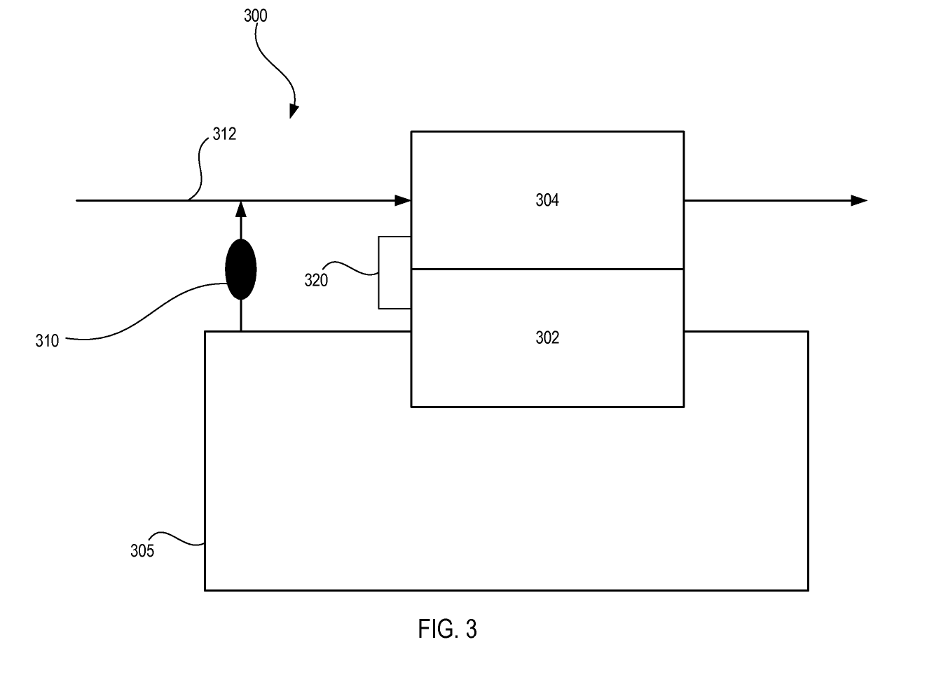

FIG. 3 is a block diagram illustrating one embodiment of a fuel cell stack 300 comprising a bleed valve and a voltage sensor that may be used to estimate a gas concentration in, for example, an anode compartment 305 of the fuel cell stack 300. As shown in this figure, fuel cell stack 300 comprises anode 302 and cathode 304. Anode 302 is coupled with an anode compartment 305, which may store one or more gases used in the fuel cell reactions, such as hydrogen gas. A bleed valve 310 is coupled with anode compartment 305, and is configured to direct gas from anode compartment 305 to a feed line 312 that leads to cathode 304.

Fuel cell stack 300 further comprises a voltage sensor 320. Voltage sensor 320 may be used to sense a drop in voltage that takes place during, or is otherwise associated with, a bleed event, such as actuating bleed valve 310. In the embodiment depicted in FIG. 3, a single voltage sensor 320 is shown. However, it should be understood that a plurality of such sensors may be used in alternative embodiments, each of which may be coupled to a different fuel cell in the fuel cell stack. In such embodiments, the system may be configured to average the drop in voltage across all, or a plurality of, the cells in the stack. It should be therefore understood that any number of sensors may be employed that are suitable for the purposes discussed herein and any number of fuel cells can be provided in the fuel cell stack 300.

The present inventors have contemplated that the voltage drop occurring during a bleed event may further be correlated with the amount of platinum oxide (PtOx) on the electrodes. Electrodes often develop a protective oxide layer during extended low power operation and could therefore show less sensitivity to such voltage drops. However, upon testing with different PtOx conditions, it appears that the impact of PtOx in the voltage drops taking place during bleed events is minimal. However, it is also contemplated that some embodiments and implementations may be configured, if configured with sufficient sensitivity, to take into account PtOx conditions in order to provide a better estimate.

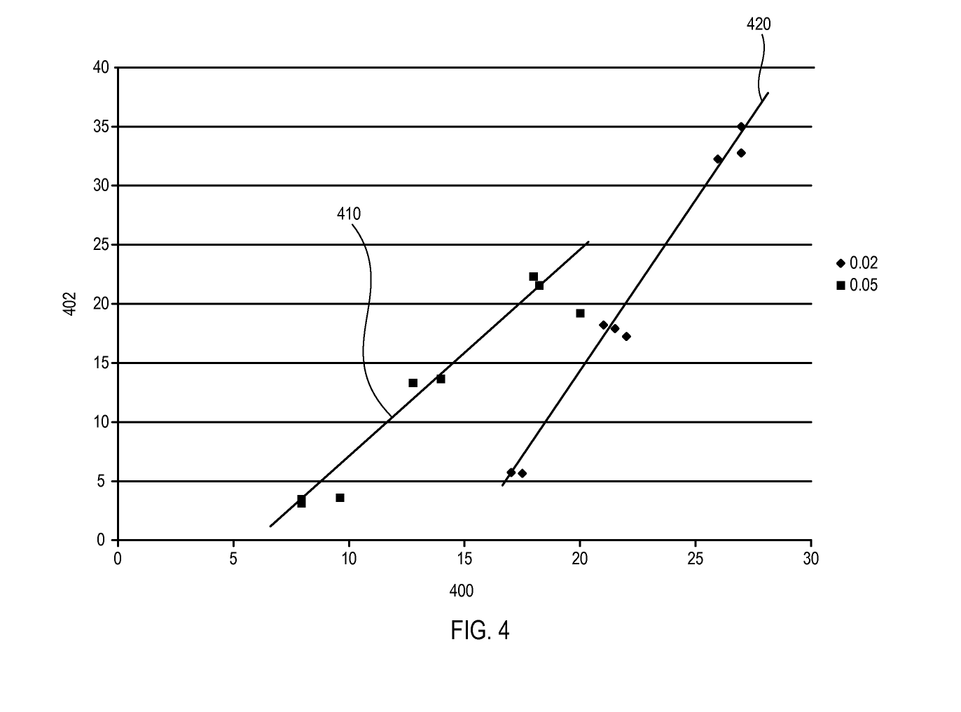

FIG. 4 is a graph illustrating relationships between voltage changes occurring during bleed events associated with a fuel cell stack and a concentration of hydrogen within an inlet of a cathode compartment of the fuel cell stack at current densities. This figure shows the extent of voltage drops during bleed events for various hydrogen concentrations in the cathode inlet of a fuel cell stack. A map similar to the one shown FIG. 4 may be used to correlate the hydrogen concentration in the cathode inlet, which may be used along with cathode flowrates (from, for example, a mass flow meter) and/or bleed flowrates (based on, for example, anode pressure bias and valve model) to estimate the hydrogen concentration in an anode subsystem. Since the anode bleed flow is a function of hydrogen concentration, the bleed flowrate and hydrogen flowrate during a bleed event may need to be estimated iteratively in some embodiments and implementations.

From the principles disclosed herein it can be seen that an algorithm for estimating one or more fuel cell stack conditions, such as the concentration of hydrogen in an anode compartment of the stack for example, may be employed in general as follows. Initially, a baseline map may be created for a given fuel cell stack and FCS design and calibration. Such a map is one example of a method for determining an at least approximate correlation between a change in voltage associated with a bleed event and a concentration of a gas in a compartment of the fuel cell stack.

This map may comprise, as described in detail herein, plotting out voltage drops during bleed events with concentration levels of one or more gases, such as hydrogen gas in the anode compartment, for example. This map may further incorporate or otherwise be associated with various other parameters and/or conditions of the stack if desired. For example, the map may incorporate different power states (such as current densities and/or air flow levels) so that a better estimate is provided that takes into account a current power state during or in close temporal proximity to the bleed event. In some embodiments and implementations, the map may be extended to cold operation, for example, if active hydrogen control during cold start transition is essential. The map may be further extended to incorporate cathode humidification levels, which may be useful to further refine the estimate.

Upon creating the map or otherwise determining an at least approximate correlation between a change in voltage associated with a bleed event and a concentration of gas in a compartment of the stack, a bleed event may be initiated. A voltage response to the bleed event (following or during the bleed event) may then be recorded. In some embodiments and implementations, the time period during which the voltage response is recorded may also be stored or otherwise used in the algorithm. In some embodiments and implementations, an initial voltage may be recorded, and the minimum voltage to back off the voltage drop may be recorded to provide an indication of the voltage change.

In some embodiments and implementations, bleed events may be configured to only take place during steady state power operation, or at least relatively stable operating conditions. For example, in some embodiments, the bleed events may only take place when power fluctuations are within a particular percentage or range of percentages of an average or steady state power operation state.

In other embodiments and implementations, voltage changes associated with transient power may be quantified by mapping such changes relative to the power change and then the remaining voltage changes may be considered to stem from the bleed event itself. In such embodiments and implementations, the bleed events may be configured to take place during steady state or transient power operation states.

The map or other means for determining an at least approximate correlation between a change in voltage associated with a bleed event and a concentration of gas in a compartment of the stack may then be used to estimate gross anode concentration. In some embodiments and implementations, this estimate may provide an accuracy to within about 20%. However, it is contemplated that the accuracy may be increased by including multiple parameters in the estimation, such as power states, temperatures, wet/dry operations, etc., as disclosed elsewhere herein.

In some embodiments and implementations, the estimate may be used to adjust one or more operational states of the vehicle. For example, the estimate may be used to adapt/correct a nitrogen buildup model such as, for example, by resetting it and/or changing a permeation factor (e.g., membrane thickness).

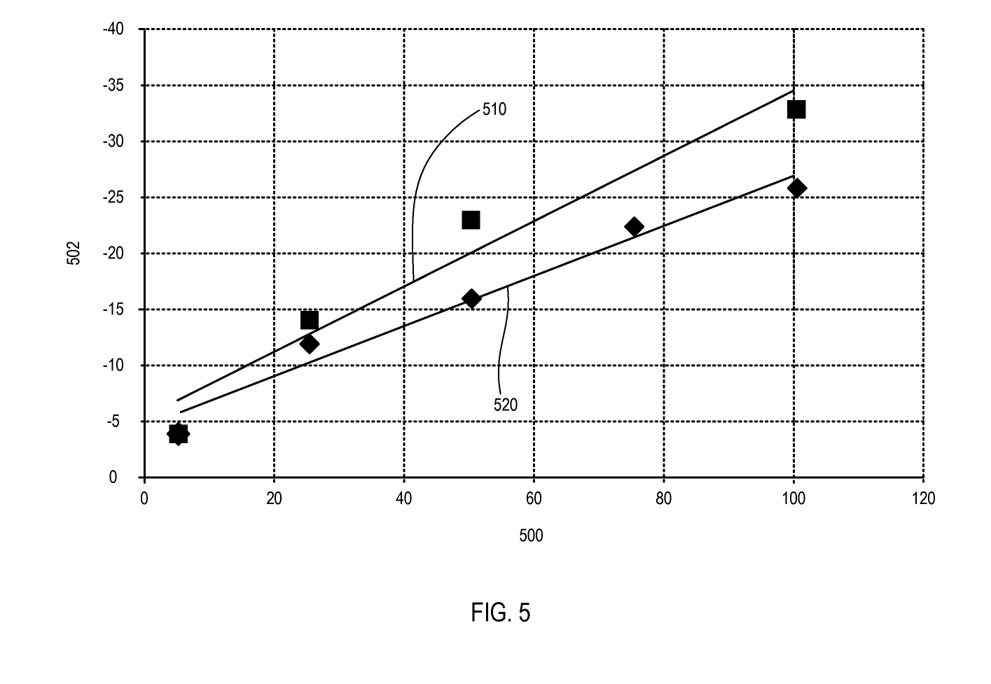

As mentioned above, some embodiments and implementations may be configured to utilize data regarding a change in voltage during a bleed event to additionally, or alternatively, estimate a pressure bias, such as an anode pressure bias. FIG. 5 is a graph illustrating a relationship between voltage changes occurring during bleed events and a pressure bias within an anode compartment of a fuel cell stack. The pressure bias (in kPa) is plotted along the “X” axis of FIG. 5 at 500. The voltage drop (in mV) measured during the bleed event is plotted along the “Y” axis of FIG. 5 at 502. As shown in this figure, the voltage drop at least roughly correlates with the pressure bias such that voltage drops may be used to estimate pressure bias. Line 510 represents an interpolation of data points used during wet operation and line 520 represents an interpolation of data points used during dry operation, which indicates that it may be useful to include this parameter in making such an estimate. The squares represent data points for wet operation used to form line 510 and the diamonds represent data points for dry operation used to form line 520.

Using voltage changes during bleed events to estimate pressure bias may be useful, for example, in connection with operation of a fuel cell stack having a failed anode pressure sensor. Currently, such operation often entails opening a bleed valve to avoid pressure buildup in the anode as a “limp home” strategy. This limp home strategy, however, would have severe limitation of vehicle range or otherwise of fuel cell operation due to constant bleeding of fuel. However, by incorporating one or more of the principles of the inventions disclosed herein, upon detecting a failed anode pressure sensor, a vehicle may be configured to operate with intermittent bleed, rather than with constant bleed, and further to monitor the voltage changes to estimate the anode pressure bias. Such an approach may be used to, for example, detect gross error in pressure and to reset mass balance-based anode pressure models as needed.

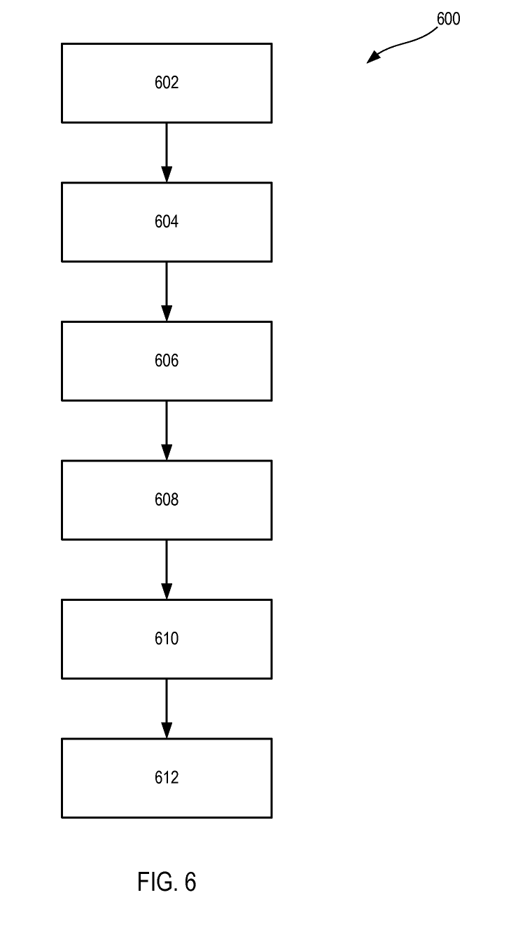

FIG. 6 is a flow chart illustrating one implementation of a method 600 for estimating a state of an anode compartment of a fuel cell stack of a fuel cell vehicle. At step 602, an at least approximate correlation between a change in voltage associated with a bleed event and a state of a fuel cell stack may be determined. In some implementations, step 602 may comprise determining an at least approximate correlation between a change in voltage associated with a bleed event and a concentration of a gas in a compartment of a fuel cell stack. In some implementations, step 602 may comprise determining an at least approximate correlation between a change in voltage associated with a bleed event and a pressure bias of a gas, such as hydrogen, within a compartment, such as an anode compartment, of a fuel cell stack. In some implementations, step 602 may comprise determining an at least approximate correlation between a change in voltage associated with a bleed event at a particular power state and/or a particular temperature and a concentration of hydrogen in an anode compartment of a fuel cell stack.

The power state may be determined, for example, by a current sensor (which in some embodiments may comprise a current density sensor) coupled with a fuel cell system of a fuel cell vehicle. Similarly, a temperature associated with the bleed event, such as a temperature of the fuel cell stack during the bleed event, may be determined by using a thermometer or other temperature sensor. In some implementations, a more general temperature may be used as a proxy for the precise temperature of the stack during the bleed event if desired.

At step 604, a bleed event may be initiated. In some implementations, step 604 may comprise opening or otherwise actuating a bleed valve. In some implementations, step 604 may further comprise allowing gas from an anode compartment to flow to a cathode compartment of the fuel cell stack. In some implementations, this may comprise opening a bleed valve that is coupled to an inlet of the cathode compartment.

At step 606, a power state associated with the bleed event may be sensed. In some implementations, step 606 may comprise sensing a current density of the fuel cell stack at or near the time of the bleed event. As should be understood from the full context of this disclosure, this step (as with many others) may be omitted in certain implementations.

At step 608, a change in voltage associated with the bleed event may then be sensed. Step 608 may comprise, for example, detecting a voltage change of the stack during the bleed event. Alternatively, step 608 may comprise detecting a voltage prior to the bleed event and comparing such a voltage with a voltage immediately following the bleed event. In other words, in some embodiments, the voltage change need not be sensed during the bleed event but may still be attributable to, and therefore considered associated with, the bleed event.

At step 610, the determined correlation between a change in voltage associated with a bleed event and a state of a fuel cell stack may be used to calculate an estimate of a concentration and/or pressure bias of a gas, such as hydrogen, in a compartment, such as the anode compartment, of the fuel cell stack. In some implementations, as mentioned above, this estimate may comprise use of additional information, such as temperature data and/or power state data, such that the estimate comprises an estimate of a concentration of gas in the compartment at a sensed temperature and/or at a sensed power state.

At step 612, one or more operational states of the vehicle may then be adjusted in response to the estimate. In some implementations, step 612 may comprise adapting a nitrogen buildup model of the fuel cell stack. In some implementations, step 612 may comprise resetting the nitrogen buildup model.

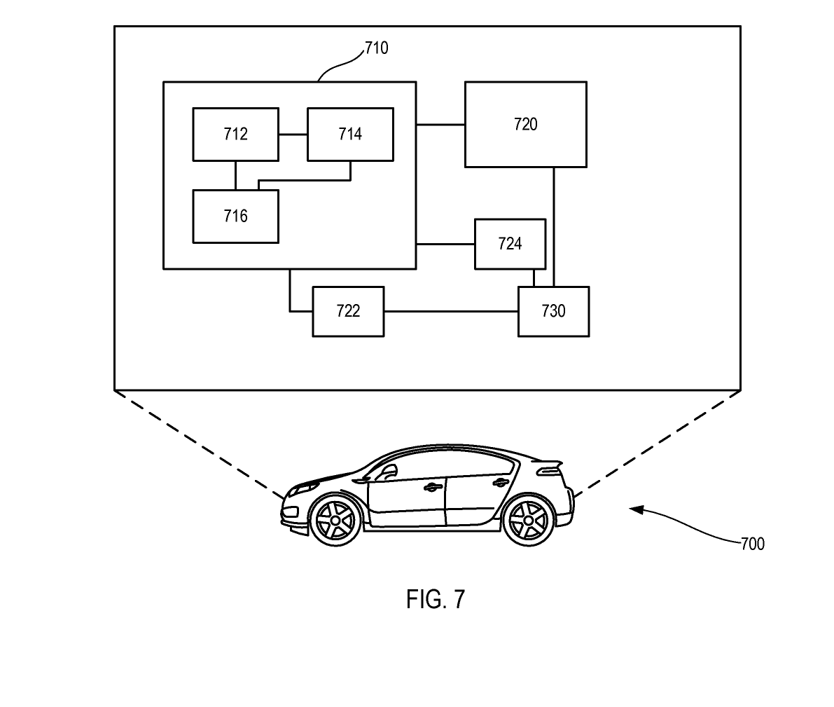

FIG. 7 illustrates an example of a vehicle 700 incorporating a system for estimating a state of an anode compartment of a fuel cell stack 710 of the vehicle 700. As shown in this figure, fuel cell stack 710 comprises an anode 712, a cathode 714, and a bleed valve 716. One or both of anode 712 and cathode 714 may comprise an associated compartment for storing one or more gases, such as hydrogen, oxygen, and nitrogen, for example. Bleed valve 716 may be operationally coupled with both anode 712 and cathode 714, as shown in the figure. Thus, as mentioned above, bleed valve 716 may, in some embodiments, be configured to, upon actuation, release gases from the anode compartment to the cathode compartment.

Vehicle 700 further comprises a voltage sensor 720, a temperature sensor 722, and a current sensor 724. Each of these sensors may be coupled with fuel cell stack 710. For example, voltage sensor 720 may be configured to sense a voltage across one or more cells in fuel cell stack 710. Of course, multiple such sensors may be employed if desired. In such embodiments, an average of the voltage reading from the plurality of voltage sensors may be used to assess a voltage change associated with a bleed event using bleed valve 716, if desired.

Similarly, multiple current sensors 724 and/or temperature sensors 722 may be provided in some embodiments. In some embodiments, current sensor(s) 724 may comprise a current density sensor.

Each of the various sensors 720, 722, and 724 may be configured to provide data during or otherwise associated with a bleed event using bleed valve 716. Such data may be transmitted to a gas concentration module 730, which may use one or more such data items to estimate a concentration of a gas and/or a pressure bias associated with fuel cell stack 710, such as a concentration of hydrogen and/or pressure bias of hydrogen associated with anode 712 of fuel cell stack 710. For example, gas concentration module 730 may be configured to use a correlation between a change in voltage associated with a bleed event using bleed valve 716 and a concentration of gas and/or gas pressure in the anode compartment to estimate the concentration and/or pressure of the gas.

Gas concentration module 730 may comprise any suitable combination of hardware, software, and/or firmware. For example, module 730 may comprise any type of computer instruction or computer executable code located within a memory device and/or m-readable storage medium, for example, and may further comprise one or more processors for executing such code. Such a module may, for example, comprise one or more physical or logical blocks of computer instructions, which may be organized as a routine, program, object, component, data structure, etc., that perform one or more tasks or implements particular abstract data types. In certain embodiments, the systems and methods disclosed herein may be implemented, at least in part, using one or more computer systems. For example, certain features and functionality of gas concentration module 730 may be implemented using a computer system comprising a processor.

Various aspects of certain embodiments may be implemented using hardware, software, firmware, or a combination thereof. As used herein, a functional module or component may comprise any type of computer instruction or computer executable code located within or on a machine-readable storage medium. A software module may, for example, comprise one or more physical or logical blocks of computer instructions, which may be organized as a routine, a program, an object, a component, a data structure, etc., that performs one or more tasks or implements particular abstract data types. The functional modules may alternatively and/or additionally be performed using hardware components and/or firmware.

Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a component, subroutine, or other unit suitable for use in a computing environment. Software embodiments may be implemented as a computer program product that comprises a non-transitory storage medium configured to store computer programs and instructions that, when executed by a processor, are configured to cause the processor to perform a method according to the instructions. In certain embodiments, the non-transitory storage medium may take any form capable of storing processor-readable instructions on a non-transitory storage medium. A non-transitory storage medium may be embodied by a compact disk, digital-video disk, a magnetic tape, a Bernoulli drive, a magnetic disk, a punch card, flash memory, integrated circuits, or any other non-transitory digital processing apparatus memory device.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices.

As shown in FIG. 7, each of the various sensors may be communicatively coupled with module 730, which, in turn, may be communicatively coupled with the fuel cell stack 710. This coupling may be particularly useful in embodiments in which module 730 is further configured to adjust one or more operational states of the vehicle. For example, module 730 may be configured to adjust a nitrogen buildup model of fuel cell stack 710. In some embodiments, module 730 may be configured to, upon receipt of information indicating that the estimated concentration and/or pressure of hydrogen or another gas associated with fuel cell stack 710 is within certain parameters, reset the nitrogen buildup model associated with fuel cell stack 710.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present invention should, therefore, be determined only by the following claims.

1. A method for estimating a state of an anode compartment of a fuel cell stack, the method comprising the steps of:
determining an at least approximate correlation between a change in voltage associated with a bleed event and a concentration of a gas in the anode compartment;
initiating a bleed event;
sensing a change in voltage associated with the bleed event; and
using the correlation to calculate an estimate of a concentration of the gas in the anode compartment.

2. The method of claim 1, wherein the change in voltage comprises an average cell voltage of a plurality of cells in the fuel cell stack.

3. The method of claim 2, wherein the average cell voltage comprises an average voltage of all of the cells in the fuel cell stack.

4. The method of claim 1, wherein the step of initiating a bleed event comprises opening a bleed valve.

5. The method of claim 4, wherein the bleed valve is configured such that, when the bleed valve is open, gas from the anode compartment is allowed to flow to an inlet of a cathode compartment of the fuel cell stack.

6. The method of claim 1, wherein the gas comprises hydrogen.

7. The method of claim 6, wherein the step of determining an at least approximate correlation between a change in voltage associated with a bleed event and a concentration of gas in the anode compartment comprises:
initiating a series of bleed events at known hydrogen concentrations; and
recording voltage changes for each of the bleed events in the series.

8. The method of claim 7, wherein the step of determining an at least approximate correlation between a change in voltage associated with a bleed event and a concentration of gas in the anode compartment further comprises:
plotting the voltage changes relative to the known hydrogen concentrations.

9. The method of claim 8, wherein the step of determining an at least approximate correlation between a change in voltage associated with a bleed event and a concentration of gas in the anode compartment further comprises:
interpolating data between the plotted voltage changes to allow for calculation of an estimated concentration of hydrogen in the anode compartment associated with voltage changes in between the plotted voltage changes.

10. A method for estimating a state of an anode compartment of a fuel cell stack of a fuel cell vehicle, the method comprising the steps of:
determining an at least approximate correlation between a change in voltage associated with a bleed event at a particular power state and a concentration of hydrogen in the anode compartment;
initiating a bleed event;
sensing a power state associated with the bleed event;
sensing a change in voltage associated with the bleed event;
using the correlation to calculate an estimate of a concentration of hydrogen in the anode compartment at the sensed power state; and
adjusting at least one operational state of the vehicle in response to the estimated concentration of hydrogen.

11. The method of claim 10, wherein the step of sensing a power state associated with the bleed event comprises sensing a current density associated with the bleed event.

12. The method of claim 10, wherein the step of adjusting at least one operational state of the vehicle comprises adapting a nitrogen buildup model of the fuel cell stack.

13. The method of claim 12, wherein the step of adjusting at least one operational state of the vehicle comprises resetting the nitrogen buildup model.

14. The method of claim 10, further comprising sensing a temperature associated with the bleed event.

15. The method of claim 14, wherein the step of using the correlation to calculate an estimate of a concentration of hydrogen in the anode compartment at the sensed power state comprises using the sensed temperature to calculate an estimate of a concentration of hydrogen in the anode compartment at the sensed power state and at the sensed temperature.

16. A vehicle, comprising:
a fuel cell stack comprising an anode compartment;
a bleed valve fluidly coupled with the anode compartment;
a voltage sensor configured to detect a voltage of the fuel cell stack associated with bleed event using the bleed valve; and
a gas concentration module for estimating a concentration of a gas in the anode compartment, wherein the gas concentration module is configured to use a correlation between a change in voltage associated with a bleed event using the bleed valve and a concentration of the gas in the anode compartment to estimate the concentration of the gas.

17. The vehicle of claim 16, wherein the fuel cell stack lacks an anode pressure sensor.

18. The vehicle of claim 16, wherein the gas comprises hydrogen.

19. The vehicle of claim 16, further comprising a temperature sensor, wherein the gas concentration module is further configured to use temperature data from the temperature sensor to estimate the concentration of the gas in the anode compartment.

20. The vehicle of claim 16, further comprising a current sensor, wherein the current sensor is configured to sense a current density during a bleed event, and wherein the gas concentration module is further configured to use data from the current density sensor obtained during a bleed event to estimate the concentration of the gas in the anode compartment.
